(19) United States
(12) Patent Application Publication
(10) Pub. No.: US 2014/0208654 A1
(43) Pub. Date: Jul. 31, 2014

(54) SLIDING PANEL ASSEMBLY

(71) Applicant: LIBERTY DIVERSIFIED INTERNATIONAL, INC., New Hope, MN (US)

(72) Inventors: Luke Adam ANDERSON, Anoka, MN (US); Jay Richard HIGASHI, Minnetonka, MN (US)

(21) Appl. No.: 14/164,788

(22) Filed: Jan. 27, 2014

Related U.S. Application Data
(60) Provisional application No. 61/757,994, filed on Jan. 29, 2013.

(51) Int. Cl. E05D 15/08; E05D 15/06

(52) U.S. Cl. CPC E05D 15/08; E05D 15/0686; E05D 15/0665
USPC 49/410

(57) ABSTRACT

A sliding panel shelf is provided that includes an upper track bracket, a slide panel clip, and a first panel. The upper track bracket includes a longitudinally-extending and downward-facing channel which includes first and second longitudinal-extending rails. The first and second longitudinal-extending rails are spaced apart from each other. The slide panel clip includes a bearing head with spaced apart first and second bearing members and first and second spaced apart depending walls. The first panel is located between the first and second spaced apart depending walls suspending the first panel from the slide panel clip.

### RELATED APPLICATIONS

This present application is related to and claims priority to U.S. Provisional Patent Application Ser. No. 61/775,944, filed on Mar. 11, 2013, entitled “Sliding Panel Assembly.” To the extent not included below, the subject matter disclosed in that application is hereby expressly incorporated into the present application.

### TECHNICAL FIELD AND SUMMARY

The present disclosure relates to retail/warehouse racking and shelving structures, and in particular to sliding cover panels for said racking and shelving structures.

Large retail stores, sometimes referred to as “big box” stores, have a common structural layout. Typically, these stores are large open-room structures with an almost warehouse-like feel where the checkout area in the front barriers a multitude of rack shelving that extend 10 to 15 feet high capable of holding almost any retail product from groceries to clothes to hardware items. One advantage of this type of retail layout is there is no longer the same need for warehousing space to be segregated from retail space. Even though these racks and shelves may extend 15 feet high, the average customer obviously cannot reach that far up. As such, the lower shelves may be used to display products for retail sale, while the upper shelves may warehouse additional stock that can be rotated down to the retail shelves as needed. Despite the benefit of this system, one issue that arises is how unsightly the upper shelves can become storing all that retail stock.

The subject matter of the present disclosure remedies this issue by describing an assembly of movable cover panels that selectively shroud or obscure the retail stock from view, creating a cleaner and possibly more inviting look. Furthermore, this assembly has the capacity to provide a substantial amount of display advertising space. The surface of these panels may serve as billboards or signage in the store.

An illustrative embodiment of the present disclosure includes a sliding panel shelf assembly. The sliding panel shelf assembly comprises upper and lower track brackets, and first, second, and third face panels. The upper track bracket is located spaced apart and above the lower track bracket. The upper track bracket also includes a longitudinally-extending and downward-facing channel In contrast, the lower track bracket includes a longitudinally-extending and upward-facing channel. The longitudinally-extending and downward-facing channel of the upper track bracket includes first and second longitudinal-extending upturned rails which are spaced apart from each other. The longitudinally-extending and upward-facing channel of the lower track bracket includes a longitudinally-extending rib that assists in forming first and second longitudinally-extending slots in the longitudinally-extending and upward-facing channel. The upper and lower track brackets are spaced apart from each other forming an opening. The first, second, and third face panels are each located in both the downward-facing channel of the upper track bracket and the upward-facing channel of the lower track bracket. Each of the first, second, and third face panels include a bearing that is engageable and movable along one of the first and second upturned rails. The first face panel is fitted in the first longitudinally-extending slot and its bearing engages the first upturned rail. The second face panel is fitted in the second longitudinally-extending slot and its bearing engages the second upturned rail. The third face panel is configured to be fitted in either the first or second longitudinally-extending slots and its bearing engages either the first or second upturned rail. The first, second, and third face panels are also configured to slide with respect to each other in the longitudinally-extending and upward-facing channel of the lower track bracket and the longitudinally-extending and downward-facing channel of the upper track bracket.

In the above and other embodiments, the sliding panel shelf assembly may further comprise: the bearings of the first, second, and third face panels bearing wheels that are engageable and movable along either the first and second upturned rail; the first and second upturned rails are each J-shaped rails; and a stop bar being selectively engagable with a notch in first face panel.

An illustrative embodiment of the present disclosure is directed to a sliding panel shelf. The sliding panel shelf assembly comprises an upper track bracket, a slide panel clip, and a first panel. The upper track bracket includes a longitudinally-extending and downward-facing channel which includes first and second longitudinal-extending rails. The first and second longitudinal-extending rails are spaced apart from each other. The slide panel clip includes a bearing head with spaced apart first and second bearing members. First and second spaced apart depending walls attached to the bearing head of the slide panel clip, and both located between the spaced apart first and second bearing members. The spaced apart first and second bearing members engage the first and second longitudinal-extending rails, respectively. The first panel is located between the first and second spaced apart depending walls suspending the first panel from the slide panel clip.

In the above and other embodiments, the sliding panel shelf assembly may further comprise: the first panel being movable along the upper track bracket; the first and second upturned rails are each J-shaped rails; a fastener that attaches the slide panel clip to the first panel.

Another illustrative embodiment of the present disclosure provides a sliding panel shelf assembly which comprises an upper track bracket, a slide panel clip, and a clamp. The upper track bracket includes a longitudinally-extending and downward-facing channel having first and second longitudinal-extending rails which are spaced apart from each other. The slide panel clip has a bearing head with spaced apart first and second bearing members, and first and second spaced apart depending walls attached to the bearing head. The first and second spaced apart depending walls are both located between the spaced apart first and second bearing members which engage the first and second longitudinal-extending rails, respectively. The clamp has first and second ends wherein the first end of the clamp is coupled to the first and second spaced apart depending walls of the slide panel clip, and the second end of the clamp is coupled to the first panel suspending the first panel from the slide panel clip.

In the above and other embodiments, the sliding panel shelf assembly may further comprise: the first panel is movable along the upper track bracket; and the first and second upturned rails are each J-shaped rails.

Additional features and advantages of the sliding panel assembly will become apparent to those skilled in the art upon consideration of the following detailed description of the illustrated embodiment exemplifying the best mode of carrying out the sliding panel assembly as presently perceived.

### BRIEF DESCRIPTION OF THE DRAWINGS

The present disclosure will be described hereafter with reference to the attached drawings which are given as non-limiting examples only, in which:

FIG. 1 is a perspective view of a sliding panel assembly;

FIG. 2 is a perspective view of the sliding panel assembly of FIG. 1 attached to a shelving system;

FIG. 3 shows front views of three face panels forming part of the sliding panel assembly;

FIG. 4 shows a portion of an upper bracket assembly;

FIG. 5 shows a portion of a lower bracket assembly;

FIG. 6 shows how a bracket assembly is attachable to a shelving system;

FIG. 7 shows how a lower track bracket assembly attaches to a support on the shelving system;

FIG. 8 shows the bracket attached to the support;

FIG. 9 shows how a fastener further secures the bracket to the support;

FIG. 10 shows another view of the fastener attaching the bracket to the support;

FIG. 11 is a side perspective view showing the upper track bracket secured to the support with the sliding panels inserted in the downward-facing channel of the upper track bracket;

FIG. 12 is a side view of the lower track bracket attached to a support with the face panels located in slots formed in the lower track bracket;

FIG. 13 is a perspective view showing a fastener that acts as a stop bar attached to the upper track bracket; and

FIG. 14 is a side view of the portion of the upper track bracket showing the stop bar engaging the face panel;

FIG. 15 is a perspective view of another illustrative embodiment of a slide panel assembly that employs a slide panel clip;

FIG. 16 is a detail perspective view of the slide panel assembly of FIG. 15 showing the orientation of the slide panel clip with respect to the rail and the panel;

FIG. 17 is another illustrative embodiment of a slide panel assembly;

FIG. 18 is detailed perspective view of a portion of the slide panel assembly of FIG. 17 showing the orientation of the slide panel clip with respect to the rail and slide panel;

FIG. 19 is a perspective view of a slide panel clip;

FIG. 20 is a detailed end view of a portion of the slide panel assembly of FIG. 17 showing how the slide panel clip rides on the rail as well as showing how the slide panel clip attaches to the slide panel; and

FIGS. 21a and b are side and end views of the slide panel clip of FIG. 19.

Corresponding reference characters indicate corresponding parts throughout the several views. The exemplification set out herein illustrates embodiments of the sliding panel assembly and clip, and such exemplification is not to be construed as limiting the scope of the sliding panel assembly and clip in any manner.

### DETAILED DESCRIPTION OF THE DRAWINGS

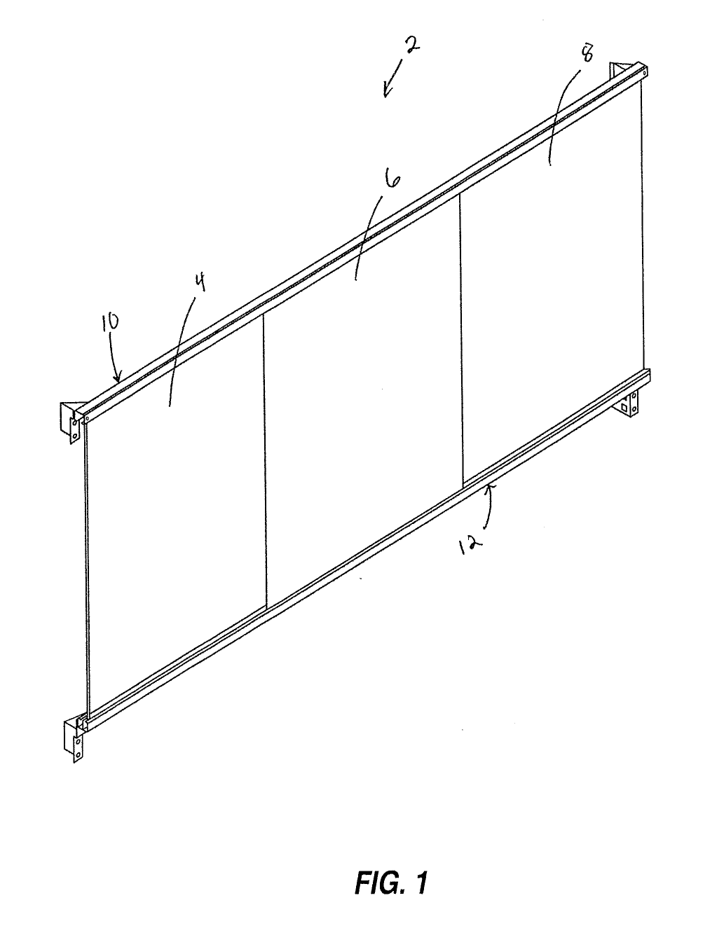

A perspective view of a sliding panel assembly 2 is shown in FIG. 1. In this illustrative embodiment, three-face panels 4, 6, and 8 are slidable between an upper track bracket 10 and lower track bracket 12. Sliding panel assembly 2 is configured to attach to conventional shelf racking assemblies that have upward extending supports and shelf members extending horizontally therebetween. As is shown, panels 4, 6, and 8 may serve to conceal the contents of what is sitting on shelving therebehind.

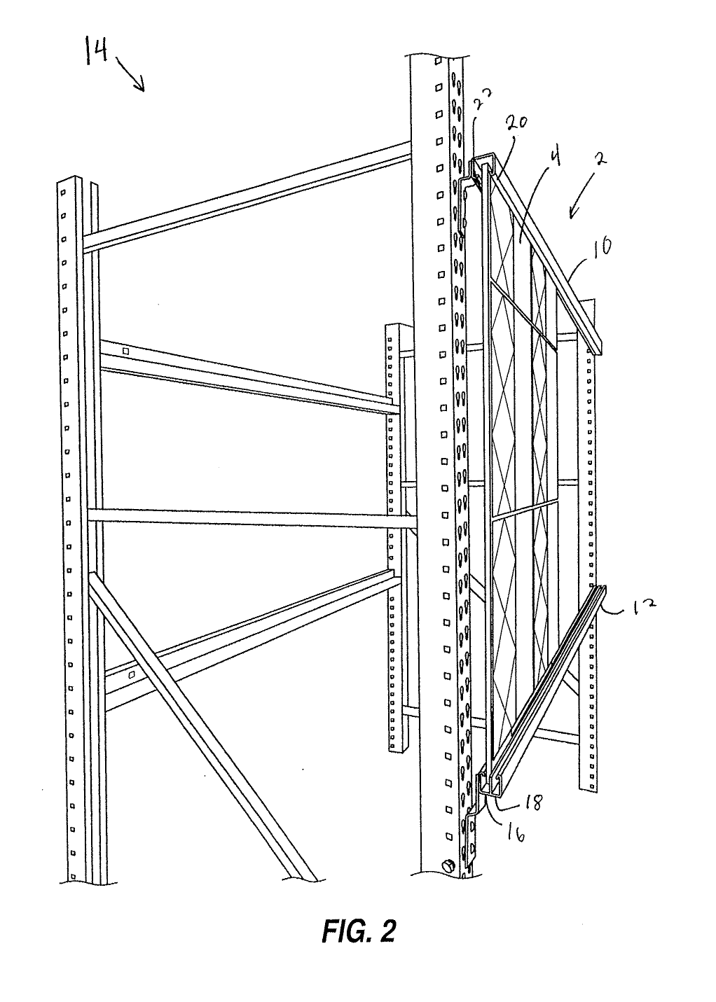

A perspective view of a shelving system 14 with sliding panel assembly 2 attached thereto is shown in FIG. 2. This view demonstrates how sliding panels such as panel 4 may serve to conceal the contents therebehind from view. This view also demonstrates how the face panels may be moved out of the way in order to access contents behind the face panels. For example, panel 4 is slidable along upper and lower tracks 10 and 12, respectively. It is notable that track 12 includes slots 16 and 18. If at least one of the face panels is located in a different slot in the lower track bracket than the other two, there is the ability for at least one face panel to slide either in front of or behind another face panel. This creates access space through sliding panel assembly 2 to gain access therebehind. In upper track bracket 10, there are bearing rails 20 and 22 located parallel to each other and each are configured to receive a bearing member located on one side of the face panel or the other, as discussed further herein. For example a face panel, such as face panel 4 has a bearing member engageable with rail 22 in upper bracket 10 and located in slot 16 of lower bracket 12, will not interfere with another face panel whose upper bearing member slides along rail 20 in upper bracket 10 and its lower end located in slot 18 of lower bracket 12. Accordingly, having adjacent panels in opposite slots and rails in the bottom and top track brackets 12 and 10, respectively, allows the face panels to both conceal what is behind the face panels while being able to selectively move out of the way to allow access behind the panels.

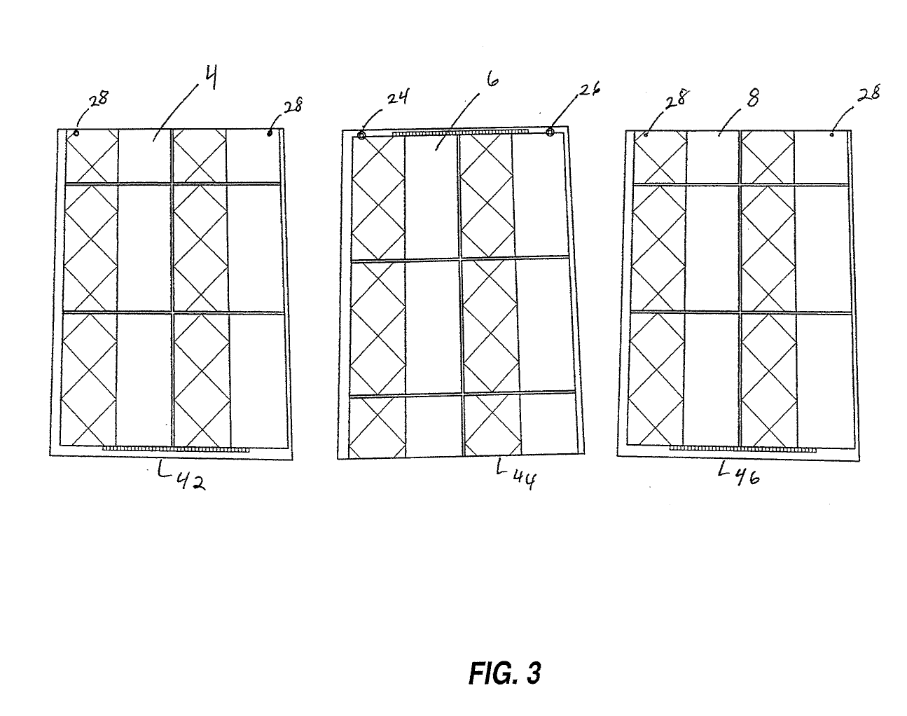

Front elevation views of three illustrative panels 4, 6, and 8 are shown in FIG. 3. It is appreciated that at least one of these panels is able to slide past an adjacent face panel to provide selective access therebehind. As shown in this illustrative embodiment, panel 6 includes bearing wheels 24 and 26 configured to engage and roll along either rail 20 or 22 of upper track bracket 10. In this embodiment, bearing wheels 24 and 26 rotate about an axle or pin 28. As shown in FIG. 3, face panels 4 and 8 only show pins 28, not bearing wheels 24, 26. This is because the bearing wheels are facing the rear. Adjacent face panels having bearing wheels facing different directions determine one face panel's ability to slide over an adjacent face panel. Here, each adjacent face panel has its bearing wheels positioned in opposite directions. In particular, face panel 4 has its bearing wheels facing the opposite direction from bearing wheels 24 and 26 shown on face panel 6. Bearing wheels 24 and 26 (not shown) on panel 4 face the rear, whereas bearing wheels 24 and 26 on face panel 6 face the front. Additionally, pins 28 are also only shown on face panel 8 because its bearing wheels face the rear just as the wheels in face panel 4 do because face panel 8 is also adjacent face panel 6. Again, the alternating arrangements facing the rear on the first panel, then facing the front on the second panel, and then facing the rear on the third panel again, allows adjacent panels to slide past each other. This view also shows how the face panels are not only useful to conceal whatever is behind them sitting on a shelf but may have a secondary utility of providing available surface area for indicia, such as marking information, signage, notices, advertisements, etc.

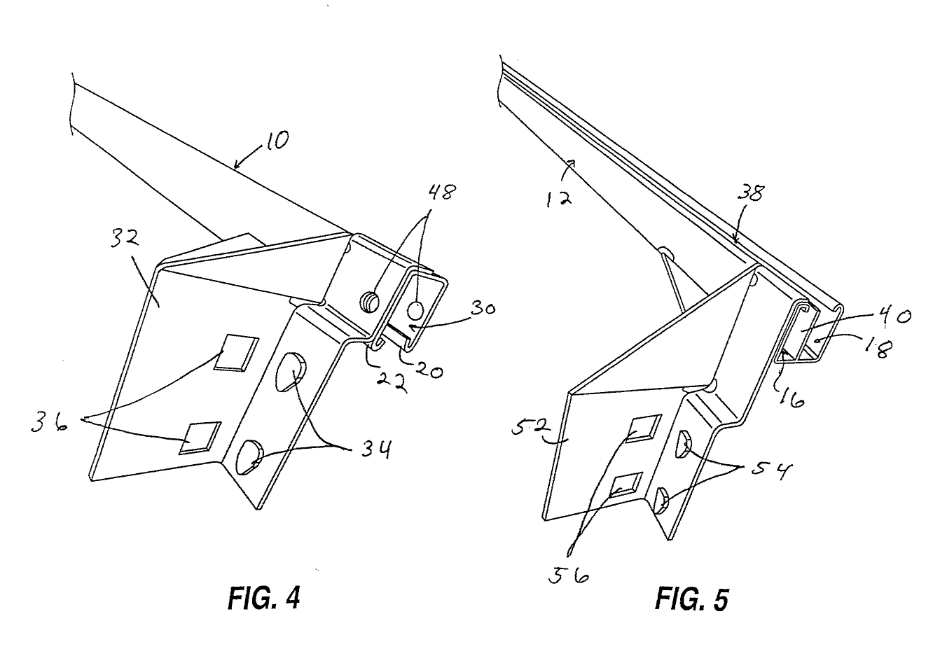

Perspective views of portions of upper and lower track brackets 10 and 12 are shown in FIGS. 4 and 5, respectively. It is appreciated that tracks 10 and 12 may be of any desired length needed to fit on a corresponding shelf system. Upper track bracket 10 is characterized by a downward-extending opening 30 terminating at the upturn bearing rails 20 and 22. As will be shown further herein, rails 20 and 22 are configured to receive bearing wheels 24 and 26 allowing for face panels 4, 6, and 8 to move along upper track bracket 10. This view also shows an attachment bracket 32 extending illustratively transverse to upper track bracket 10 and configured to attach to an upright support on a shelf system. It is appreciated that such attachment brackets 32 may be located at each end of upper track bracket 10. In this illustrative embodiment, attachment bracket 32 includes lugs 34 and holes 36 configured to assist securing brackets 10 and 32 onto the shelf supports, as discussed further herein. In an illustrative embodiment, stop bar holes 48 may be disposed through brackets 10 and 32 to receive a stop bar which limits the movement of the face panels, as also discussed further herein.

Lower track bracket 12 includes an upward-extending opening 38 and a longitudinally-extending rib 40 that forms slots 16 and 18. These slots illustratively run the length of bracket 12 and are configured to receive the lower portions of face panels 4, 6, and 8. As discussed further herein, similar to how the bearing wheels 24 and 26 are attached to either the rear or front of the face panels in alternating fashion, the lower ends of face panels 4, 6, and 8 are placed in either slot 16 or 18 in alternating fashion. For example, face panel 4 having rearward facing bearing wheels will have its lower end 42 illustratively located in rear slot 16 (see also FIG. 3). Alternately, face panel 6 having front-facing roller bearings 24 and 26 will have its lower end 44 illustratively located in front slot 18. And then alternately, face panel 8 with its roller bearings 24 and 26 again rearward facing, will have its lower end 46 located in rear slot 16 similar to face panel 4. This means face panel 6 located in front slot 18 will be able to slide over either face panel 4 or face panel 8. Likewise, face panel 4 will be able to slide unobstructed behind face panel 6. The same with face panel 8, it too will also be able to slide behind face panel 6. By moving at least one of the three panels, an opening is selectively formed exposing the shelf space therebehind. Whenever access to the shelf is no longer needed, the panels may be slid back into place covering the space.

Like upper track bracket 10, lower track bracket 12 as shown in FIG. 5 includes an attachment bracket 52 that includes lugs 54 and holes 56 similar to lugs 34 and holes 36 on bracket 10. It is appreciated that a mirror image of bracket 52 is attached to bracket 12 at the opposite end to attach to an opposite shelf support.

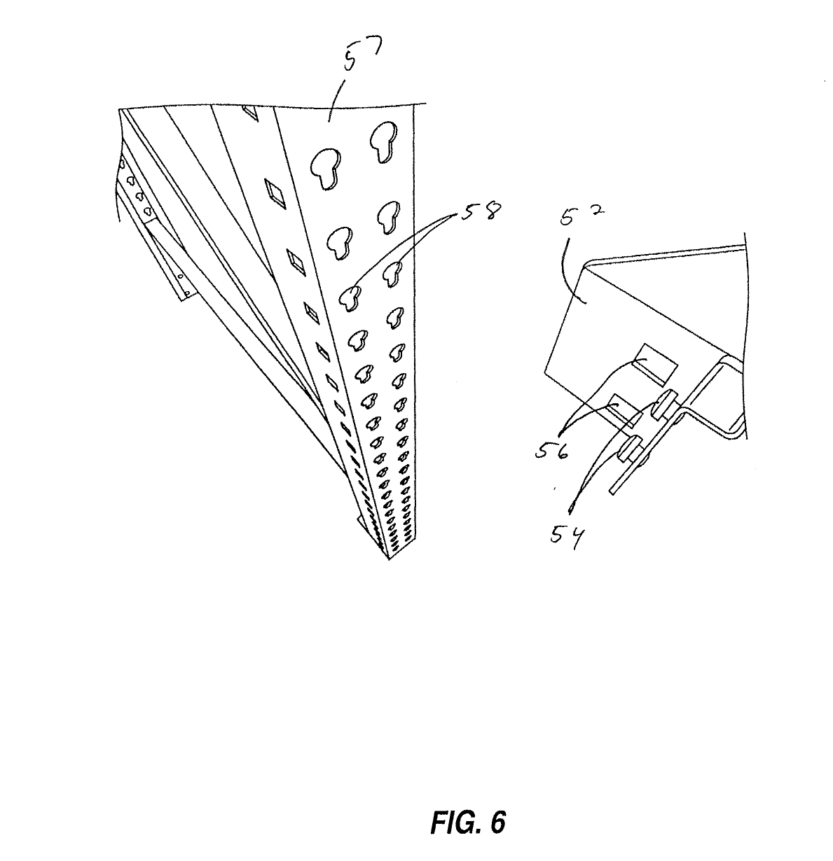

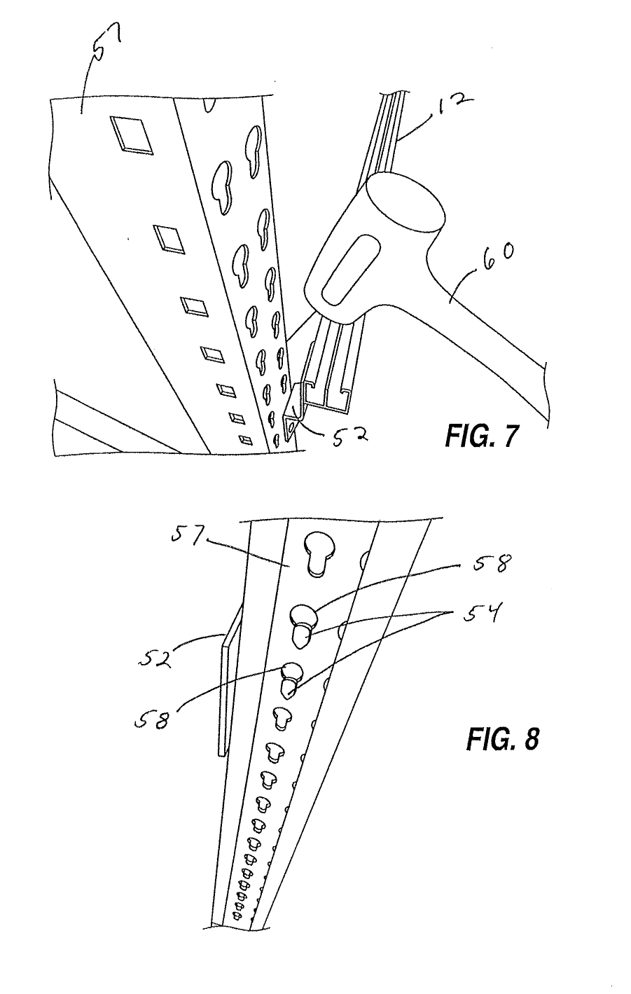

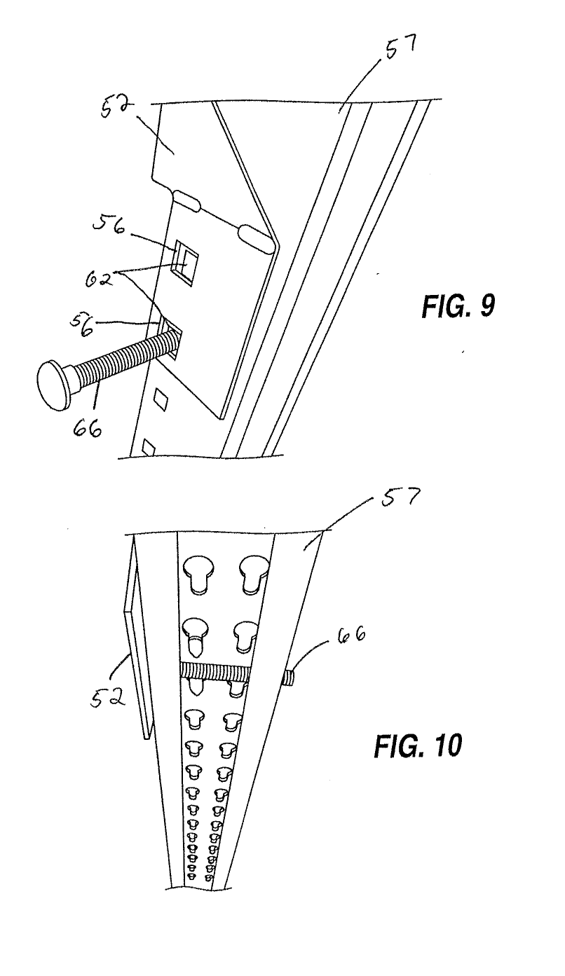

Progression views depicting how attachment bracket 52 (similar to attachment bracket 32) attaches to shelf support member 57 are shown in FIGS. 6 through 10. As FIG. 6 shows, lugs 54 (or 34) are lined up with corresponding key holes 58 on shelf support member 57. Bracket 52 is then attached to shelf support member 57 illustratively using a mallet 60 or other striking device to cause lugs 54 to engage the periphery of key hole 58, as shown in FIGS. 7 and 8. It is appreciated that a similar procedure is performed for bracket 32 and at both sides of brackets 10 and 12. Illustratively, when lugs 54 are secured in keyhole 58, holes 56 (and 36) mate with corresponding holes 56 of bracket 52. With holes 56 and 62 lined up, a fastener such as bolt 66 is disposed therethrough as shown in FIGS. 9 and 10. Bolt 66 is configured to accept a nut to securely fasten attachment bracket 52 (or 32) to shelf support number 57. It is appreciated that upper track bracket 10 and lower track bracket 12 may be spaced apart a distance sufficient to fit a face panel of desired dimension to provide the appropriate or desired concealment. It is further appreciated that when properly attached to shelf support 57, lower track bracket 12 will have its opening 38 facing upward and the upper track bracket 10 will have its opening 30 face downward.

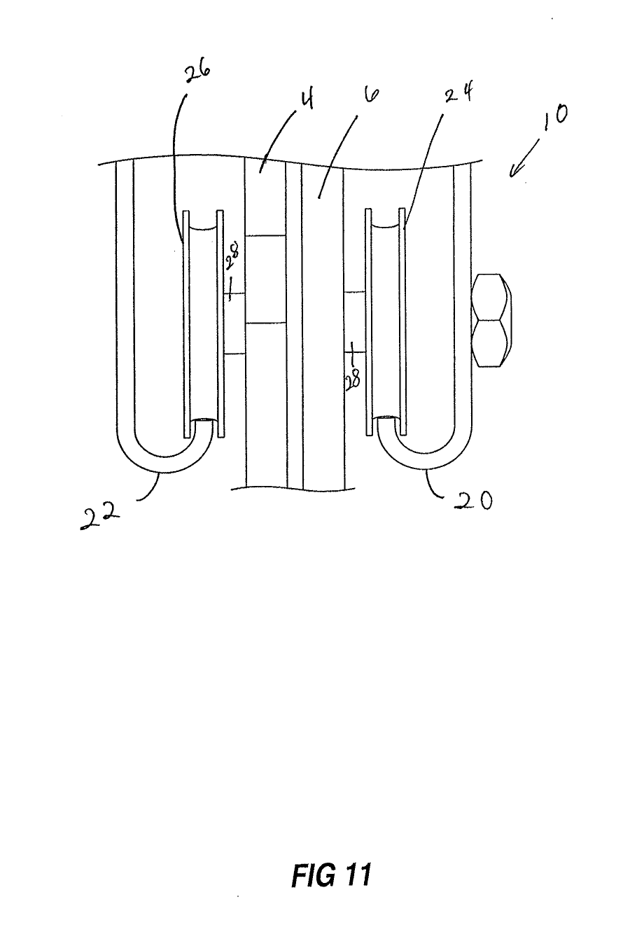

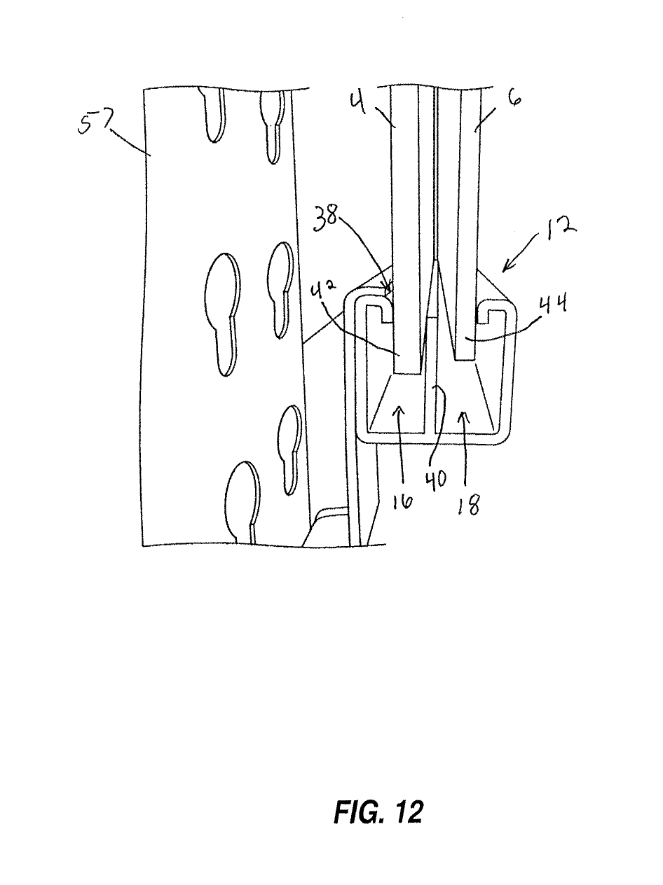

A perspective detailed view of upper track bracket 10 and lower track bracket 12 attached to shelf support member 57 with face panel members 4 and 6 installed therein is shown in FIGS. 11 and 12, respectively. As shown in FIG. 11, roller 24 (and 26, not shown in this view) run on bearing rail 20 inside bracket 10. Similarly, face panel 4 includes bearing wheel 26 (and bearing wheel 24, not shown in this view) running on bearing rail 22. It can be appreciated from this view how at least at upper track bracket 10 both face panels 4 and 6 may slide over each other without any interference from the coupling points, i.e., bearing wheels 24 and 26. It is further appreciated that face panel 8 although not shown in this view may have its bearing wheels coupled to bearing rail 22 and not interfere with at least face panel 6. In another embodiment, depending on the desired configuration, face panel 6 may alternatively have its bearing wheels face forward and ride on bearing rail 20.

Lower ends 42, 44, and 46 of face panels 4, 6, and 8, respectively, may be fitted in opening 38 of lower track bracket 12 in FIG. 12. Particularly, lower end 44 of face panel 6 is fitted in slot 18 of bracket 12. Likewise face panel 4 is fitted in slot 16 of bracket 12. Because rib 40 extends through bracket 12, lower ends 42 and 44 are kept separate from each other and do not interfere when face panels 4 and 6 overlap each other.

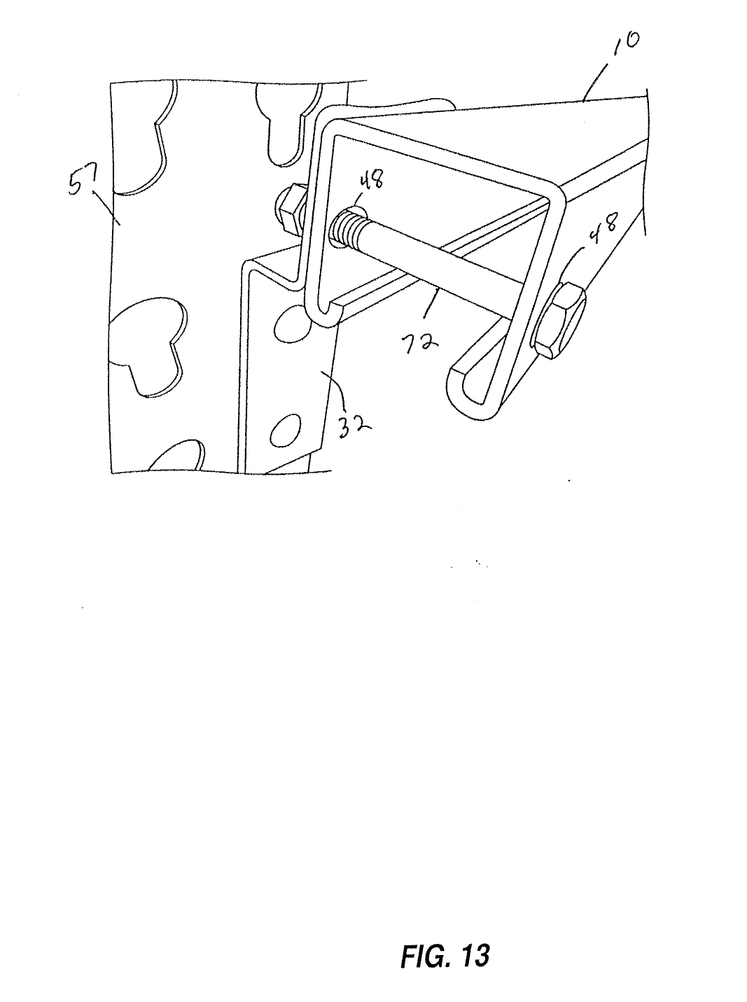

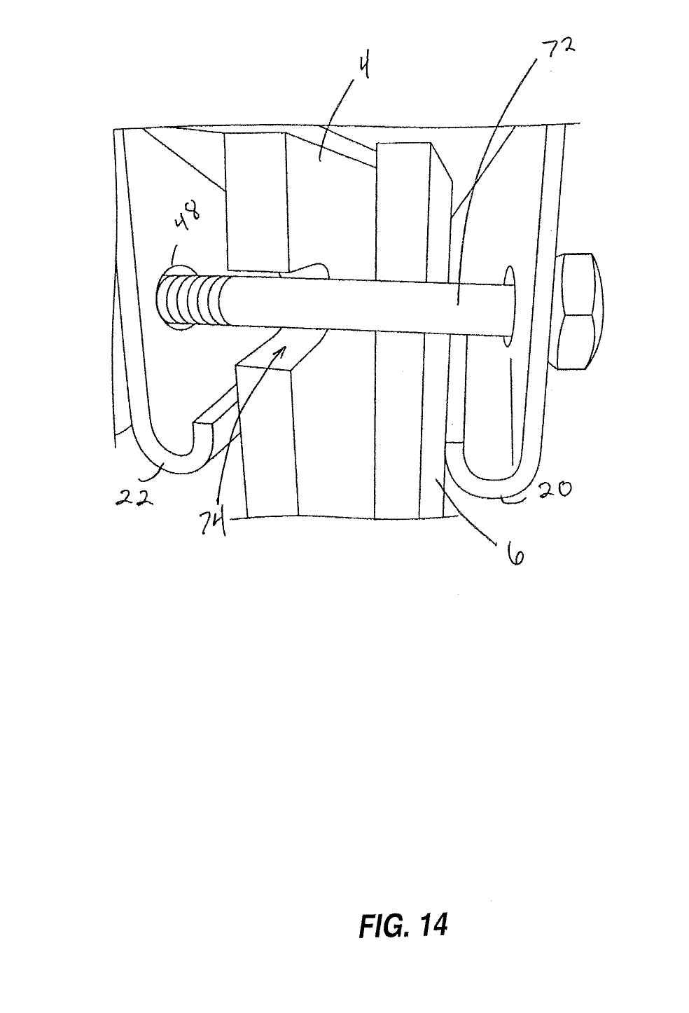

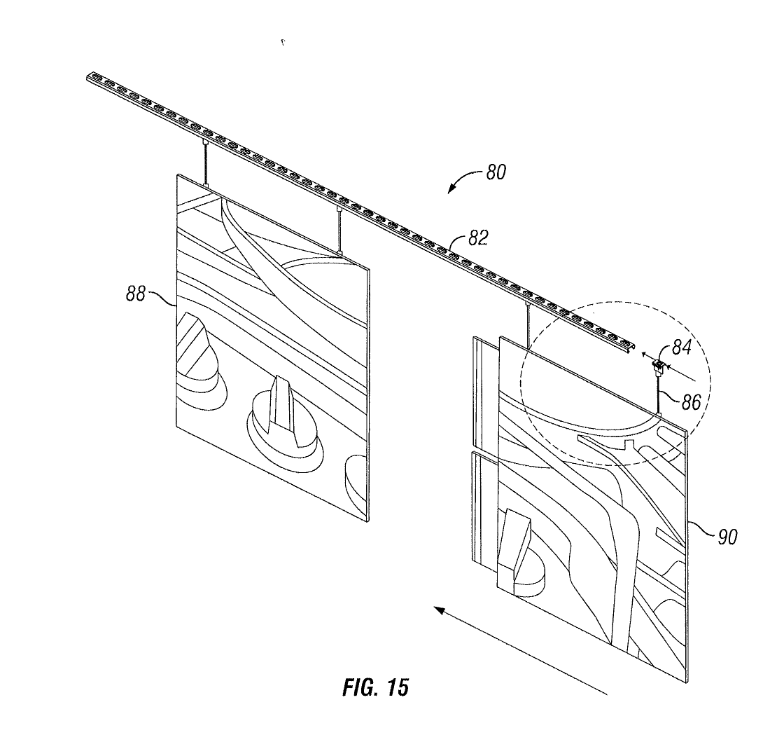

In order to limit movement of face panels 4, 6, and 8, a stop may be placed at the ends of either the upper or lower brackets. The stop in essence provides a barrier that limits the movement of the face panels. As shown in the perspective detail views of FIGS. 13 and 14, a stop bar 72 in the form of a bolt is disposed through holes 48 on each side of upper track bracket 10. As shown in FIG. 14, one or more of the face panels such as face panel 4 may include a notch 74 that stop bar 72 fits into to limit the movement of the face panel.

An illustrative embodiment of this present disclosure includes a sliding panel assembly configured to attach to conventional shelf racking assemblies that have upward extending supports and shelves extending horizontally therebetween. The sliding panel assembly includes top and bottom tracks, each spaced apart from each other, and extending between the upward extending supports. The bottom track extends between the two supports adjacent to a bottom shelf, while the top track extends adjacent the next shelf above. This allows the panels to cover the space between the lower and upper shelves.

With regard to the panels, in one illustrative embodiment, a three-panel system is provided where one panel is slidable either in front of or behind the other two sliding panels. This allows the panels to be moved out of the way creating convenient access to the stock behind the panels, while still able to selectively shroud the entire width of the space between the lower and upper shelves.

It is appreciated that depending on the width of the warehouse racking more or less than three sliding panels may be used. For example, in another embodiment, four sliding panels may be used. Two panels may be configured to slide either in front of or behind the other two panels. Illustratively, another embodiment may include just two panels where one panel slides either in front of or behind another moving panel. In another embodiment, in the three, four, or more moving panels systems, each adjacent panel is either in front of or behind the panel next to it. It is further appreciated that these panels, tracks, etc. may be any variety of sizes, large or small, to accommodate any of the variety of retail racking and shelving sizes.

A perspective view of another illustrative embodiment of slide panel 80 is shown in FIG. 15. This embodiment includes an upper track 82, slide panel clip 84, C-hook 86, and panels 88 and 90. As shown herein, slide panel clip 84 engages upper track 82 holding and suspending panels 88 and 90. Upper track 82 is similar in configuration to upper track 10 previously discussed. Clips 84 are configured to removably hold panels 88 and 90. Similar to the prior embodiments, panels 88 and 90 are intended to conceal the contents behind rack shelving. Panels 88 and 90 are suspended from upper track 82 and may illustratively attach to each other and adjacent panels to provide a large graphical surface. It is appreciated that although this embodiment shows two slide panel clips 84 employed to suspend a single panel, more or less such clips may be used depending on the configuration and weight, for example, of the panels, as well as the needed configuration of assembly 80. The surface of panels 88 and 90 (as well as additional panels if needed) may be used for indicia such as advertising, information, or other purposes, as discussed previously.

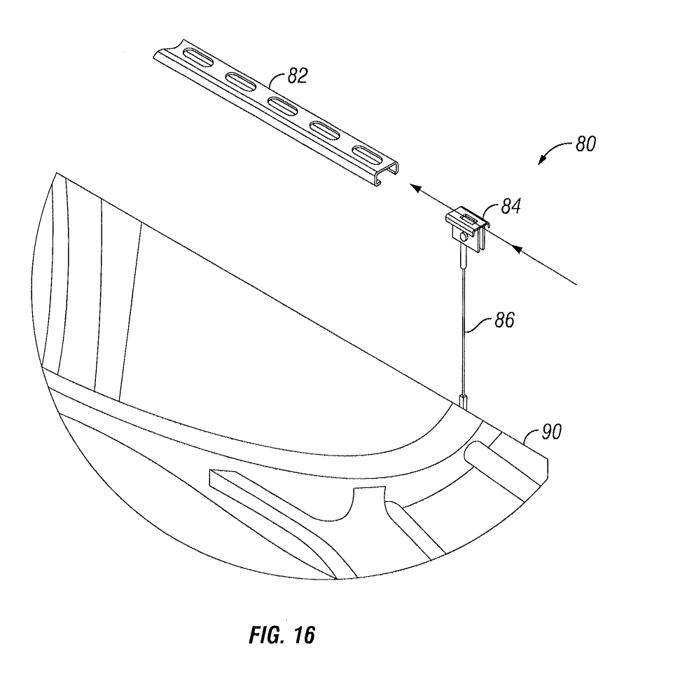

A detailed perspective view of slide panel assembly 80 is also shown in FIG. 16. This view shows C-hook 86 attaching to both slide panel clip 84 and panel 90. Slide panel clip 84 may then be slid in the end of upper track 82. It is appreciated that slide panel clip 84 may slide to any various position along track 82 in order to locate an attached panel to any desired position.

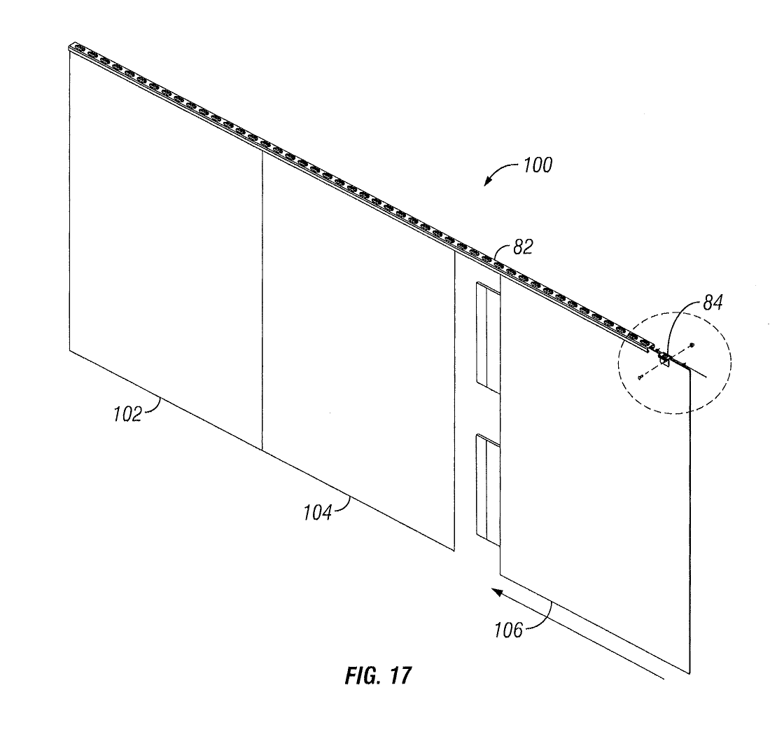

Another illustrative embodiment of the sliding panel assembly 100 is shown in FIG. 17. This embodiment also includes upper track 82 along with panels 102, 104 and 106 that are coupled to upper track 82 via a plurality of slide panel clips 84. It is appreciated that any number of panels may be employed along upper track 82 as desired. Additionally, any number of clips 84 as needed may be used to suspend the panels from upper track 82. In this embodiment, however, rather than employing C-hook 86 as previously discussed, slide panel clip 84 is attached directly to the panels, such as panel 106, for example.

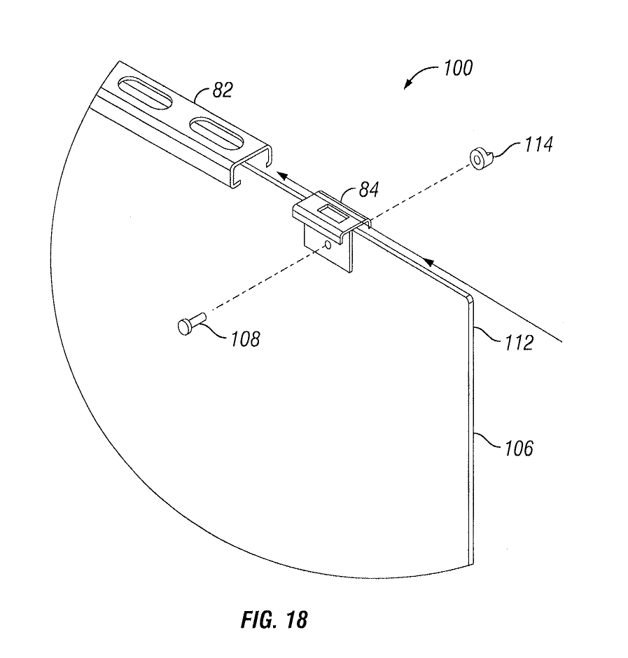

The detail perspective view of assembly 100 shown in FIG. 18 depicts how a fastener 108 may be disposed through a hole 110 in depending side walls 112 and 113 of slide panel clip 84. It is appreciated that a corresponding hole may be formed in panel 106 such that fastener 108 extends to the other side of slide panel clip 84 and couples to a nut 114 securing panel 106 to slide panel clip 84. Illustratively fastener 108 and nut 114 may be a Viking clip screw and nut. Again, it is appreciated that any number of slide panel clips 84 may be so attached to a panel to securely suspend the panel from upper track 82. The more panels (and/or larger panels) that are employed may create a larger graphical area than just using one panel alone.

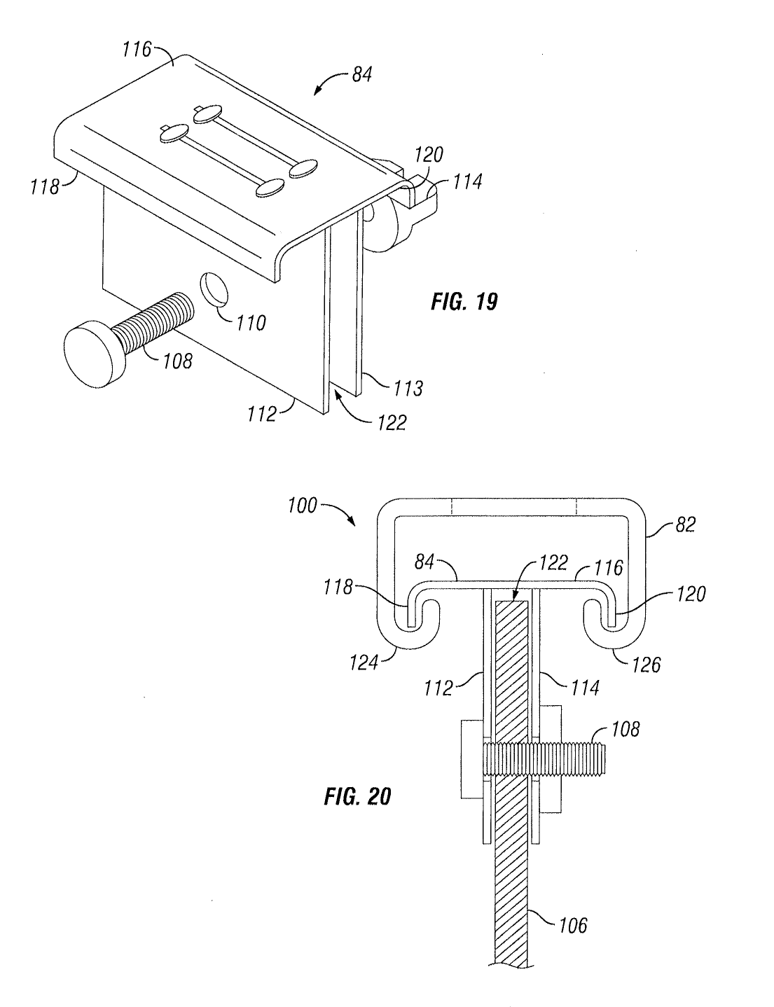

A perspective view of slide panel clip 84 along with fastener 108 and nut 114 are shown in FIG. 19. The primary structures of slide panel clip 84 include a bearing head 116 and depending side walls 112 and 113. Illustratively, side walls 112 and 113 may be spot welded on to bearing head 116. As shown in this embodiment, bearing members 118 and 120 also depend from head 116 and are spaced apart from depending side walls 112 and 113. As shown further, bearing numbers 118 and 120 are configured to engage upper track 82 so that the attached panels may slide along track 82 as well. Hole 110 extends through both depending side walls 112 and 113 to receive fastener 108. As previously mentioned, a corresponding hole in a panel is formed so that when panel is received in open space 122 between depending side walls 112 and 113 the hole lines up with holes 110 so fastener 108 may extend through all three structures and secure to slide panel clip 84 with the assistance of nut 114. It is appreciated, however, that other fastening means including adhesives, rivots, or other mechanical or chemical adhesive mechanisms may be employed to attach to slide panel clip 84 either selectively or permanently, depending on the needs of the circumstances.

A detail end view of a portion of slide panel assembly 100 is shown in FIG. 20. This view demonstrates how slide panel clip 84 engages upper track 82 for suspending panel 106 (as well as any other panel). Upper track 12 includes upturn bearing rails 124 and 126 similar to rails 20 and 22 of upper bracket 10, previously discussed with respect to one of the prior embodiments. Bearing members 118 and 120 of bearing head 116 ride along bearing rails 124 and 126, respectively, as shown. It is appreciated from this view how upper track 82 holds and suspends both slide rail clip 84 and panel 106 securely. Because in this illustrative embodiment bearing rails 124 and 126 are upturned, slide panel clip 84 will not derail from upper track 82 accept from the end. This view also shows how fastener 108 is disposed through depending side walls 112 and 113 as well as panel 106. Because open space 122 is configured to receive sliding panel 6 (as well as any other panel) slide panel clip 84 securely attaches to panel 106 and is suspended from upper track 82.

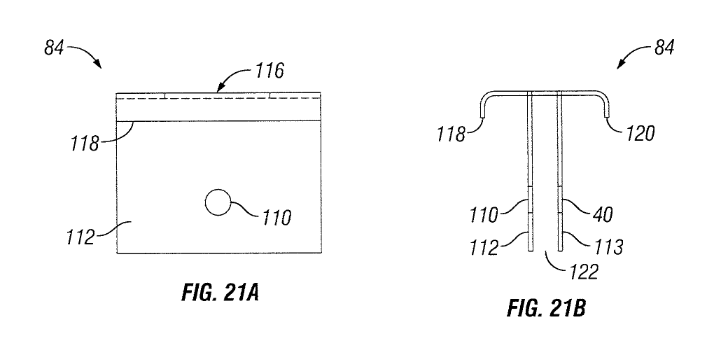

Side and end views of side panel clip 84 are shown in FIGS. 21a and b, respectively. The view shown in FIG. 21a includes bearing head 116, depending side wall 112, hole 110 and bearing member 118. The end view shown in FIG. 21b shows both bearing members 118 and 120 along with openings 110 in both depending side walls 112 and 113 forming open space 122.

Although the present disclosure has been described with reference to particular means, materials and embodiments, from the foregoing description, one skilled in the art can easily ascertain the essential characteristics of the disclosure and various changes and modifications may be made to adapt the various uses and characteristics without departing from the spirit and scope of this disclosure.

What is claimed:

1. A sliding panel shelf assembly comprising:
an upper track bracket;
wherein the upper track bracket includes a longitudinally-extending and downward-facing channel;
wherein the longitudinally-extending and downward-facing channel of the upper track bracket includes first and second longitudinal-extending rails;
wherein the first and second longitudinal-extending rails are spaced apart from each other;
a slide panel clip having a bearing head with spaced apart first and second bearing members, and first and second spaced apart depending walls attached to the bearing head and both located between the spaced apart first and second bearing members;
wherein the spaced apart first and second bearing members engage the first and second longitudinal-extending rails, respectively;
a first panel located between the first and second spaced apart depending walls suspending the first panel from the slide panel clip.

2. The sliding panel shelf assembly of claim 1, wherein the first panel is movable along the upper track bracket.

3. The sliding panel shelf assembly of claim 1, wherein the first and second upturned rails are each J-shaped rails.

4. The sliding panel shelf assembly of claim 1, further comprising a fastener that attaches the slide panel clip to the first panel.

5. A sliding panel shelf assembly comprising:
an upper track bracket;
wherein the upper track bracket includes a longitudinally-extending and downward-facing channel;
wherein the longitudinally-extending and downward-facing channel of the upper track bracket includes first and second longitudinal-extending rails;
wherein the first and second longitudinal-extending rails are spaced apart from each other;
a slide panel clip having a bearing head with spaced apart first and second bearing members, and first and second spaced apart depending walls attached to the bearing head and both located between the spaced apart first and second bearing members;
wherein the spaced apart first and second bearing members engage the first and second longitudinal-extending rails, respectively;
a clamp having first and second ends;
wherein the first end of the clamp is coupled to the first and second spaced apart depending walls of the slide panel clip;
a first panel;
wherein the second end of the clamp is coupled to the first panel suspending the first panel from the slide panel clip.

6. The sliding panel shelf assembly of claim 1, wherein the first panel is movable along the upper track bracket.

7. The sliding panel shelf assembly of claim 1, wherein the first and second upturned rails are each J-shaped rails.
